(19) United States
(12) Patent Application Publication
(10) Pub. No.: US 2025/0389095 A1
(43) Pub. Date: Dec. 25, 2025

(54) BIODEGRADABLE FLOOR SEALING MEMBRANE

(71) Applicant: NAUE GMBH & CO. KG, Espelkamp (DE)

(72) Inventors: HENNING EHRENBERG, Espelkamp (DE); MARTIN TAZL, Espelkemp (DE); LARS VOLLMERT, Espelkamp (DE)

(73) Assignee: NAUE GMBH & CO. KG, Espelkamp (DE)

(21) Appl. No.: 18/878,444

(22) PCT Filed: Jun. 28, 2023
(86) PCT No.: PCT/EP2023/067581

§ 371 Date: Dec. 23, 2024

(30) Foreign Application Priority Data
Jun. 28, 2022 (DE) 20 2022 103 585.7

(51) Int. Cl. E02B 3/12; B32B 5/02; B32B 5/26; B32B 7/09; E02D 17/20

(52) U.S. Cl. CPC E02B 3/122; B32B 5/022; B32B 5/024; B32B 5/263; B32B 5/266; B32B 7/09; E02D 17/202; B32B 2262/124; B32B 2262/128; B32B 2307/7163; E02D 2250/00; E02D 2300/0006; E02D 2300/0051; E02D 2300/0076; E02D 2300/0078; E02D 2300/009

(57) ABSTRACT

A geosynthetic mat comprises an upper and a lower cover layer and a middle filler layer arranged between the upper cover layer and the lower cover layer and consisting of a filler layer material comprising a swellable material. The top cover layer and/or the bottom cover layer consist of a biodegradable material or comprise a biodegradable material, the peel strength being characterised by a residual peel strength degree at a predetermined point in time after the start of the biodegradation process, which is formed by the square number of a quotient of a reduced peel strength, which the upper and lower cover layer and a connecting structure have at the predetermined point in time, to an initial peel strength, which the upper and lower cover layer and the connecting structure have before the start of a biodegradation process.

### CROSS-REFERENCE TO FOREIGN PRIORITY APPLICATION

The present application claims the benefit under 35 U.S.C. §§ 119(b), 119(e), 120, and/or 365(c) of PCT/EP2023/067581 filed Jun. 28, 2023, which claims priority to Germa Application No. DE 20 2022 103 585.7 filed Jun. 28, 2022.

### FIELD OF THE INVENTION

The invention relates to a geosynthetic mat comprising a top cover layer, a bottom cover layer, a middle filler layer arranged between the top cover layer and the bottom cover layer and made of a filler layer material comprising a swellable material, the filler layer material having a swelling behaviour, and a connection structure by means of which the top and bottom cover layers are mechanically connected to each other at several positions through the middle filler layer, the positions of the connection being spaced apart from each other, preferably at a regular distance from each other along straight lines, by means of which the upper and lower cover layers are mechanically connected to one another at a plurality of positions through the centre filler layer, the positions of the connection being spaced apart from one another, preferably at a regular distance from one another along straight lines following positions, so that the upper and lower cover layers have peel strength relative to one another due to the connection structure.

The filling layer material has a swelling behaviour which is typically characterised at a predetermined point in time after the start of the swelling process by a degree of swelling which is determined by the ratio of the volume of the filling layer material including the water absorbed therein at the predetermined point in time to an initial volume of the filling layer material, which the filling layer material has before the start of the swelling process, wherein the degree of swelling is determined by completely immersing the geosynthetic mat in a water bath for a period of time up to the predetermined time and determining the volume of the filling layer material before immersion and at the predetermined time. The degree of swelling therefore indicates the swelling capacity of a material in unhindered conditions and can be determined according to ASTM D5890, for example. For example, a defined quantity (2 g) of dry filler layer material is placed in a 100 ml measuring cylinder filled with 90 ml of water. It is then filled up to 100 ml with water. The filler layer material sinks to the bottom and an initial volume of the filler layer material can be read off the scale of the measuring cylinder immediately after the filler layer material has been added. The filling layer material then swells for a predetermined period of time, for example at least 16 hours. The swelling volume can then be read off by determining the height of the swollen filler layer material using the scale on the measuring cylinder and the degree of swelling can be determined by calculating the quotient with the initial volume.

A further aspect of the invention is a use of such a geosynthetic mat and a method for producing such a geosynthetic mat.

Geosynthetic mats of the aforementioned type are used to create a seal on a soil layer or within a soil; in other applications, such geosynthetic mats can also be used to additionally stabilise a soil layer and/or protect a structure against mechanical or hydraulic impacts or combinations thereof, for example in the area of a watercourse or channel bank, an embankment, a barrier dam or a dyke structure. They can also be used to protect other thin-layer sealing components.

The functional principle of such geosynthetic mats is that the centre filler layer, which is typically many times thicker than the top cover layer and the bottom cover layer, is not swollen or hardened in the state immediately after production and therefore has a mechanical flexibility that allows the geosynthetic mat to be rolled up into a roll. On the one hand, this makes the geosynthetic mat transportable and, on the other hand, this flexibility allows the geosynthetic mat to mould to the ground topology at the installation site. The geosynthetic mat is then rolled out at the installation site; if necessary, a floor area wider than the width of the geosynthetic mat transverse to its longitudinal direction, which corresponds to the roll-out direction, can also be covered by rolling out several geosynthetic mats parallel and overlapping next to each other.

After installation, the middle filler layer swells due to water absorption, which can be caused by soil moisture at the installation site and can also be accelerated by an artificial water supply if necessary. This swelling causes a homogenisation and a decrease in the air void volume of the middle filler layer, as a result of which it achieves the desired homogeneous and largely isotropic very low water permeability, characterised by the permeability parameter k₁₀, which ideally can be less than 5×10⁻¹⁰ and preferably less than 5×10⁻¹¹ m/s after swelling of the middle filler layer. However, this homogenisation and decrease in the air void volume requires that the middle filler layer cannot expand unhindered, which requires the influence of the interconnected top and bottom cover layers as mechanical counter-pressure, which results in the desired limitation of the volume increase. In certain installation situations or installation phases, such counter-pressure can also be caused or increased by surface pressure on the upper cover layer, which is achieved by the installation of soil layers above the geosynthetic mat via its weight. The low water permeability achieved results in a sufficiently high sealing effect to be able to retain water in standing or flowing bodies of water, to provide landfill sealing or to protect dyke structures against moisture penetration.

The top and bottom cover layers and the connecting structure that joins these two cover layers together therefore fulfil essential functions that are necessary for the use and properties of the geosynthetic mat. On the one hand, the geosynthetic mat can be rolled up and handled thanks to the top layers and the connecting structure and consequently retains its structure with the centre filler layer positioned between the two top layers in a desired thickness even when rolled up after production, during transport and when laid at the installation site. After installation of the geosynthetic mat, the two cover layers and the connecting structure continue to generate and maintain mechanical stabilisation and therefore a mechanical counter-pressure against the swelling pressure of the middle filler layer, whereby the middle filler layer develops a desired, dense structure during swelling. According to the inventors, this swelling under the mechanical counterpressure, which is achieved by the constriction of the centre filling layer between the two cover layers and the connecting structure, is the only way to achieve the desired low permeability of the geosynthetic mat after the centre filling layer has swelled, and this low permeability should in the best case be achieved regardless of whether or not a layer with a certain weight can be installed above the geosynthetic mat.

Finally, in installation situations in which a geosynthetic mat of the aforementioned type is installed at an angle, for example on a slope, the geosynthetic mat must have shear strength in order to prevent the geosynthetic mat itself from constituting or forming an unstable layer in the slope and consequently a slope slip could occur with the geosynthetic mat as a separating layer. This shear strength is achieved by the connecting structure between the upper and lower cover layers, whereby a stable connection is achieved between the lower soil layer, on which the lower cover layer rests, and the upper soil layer resting on the upper cover layer.

### BACKGROUND OF THE INVENTION

Geosynthetic mats of the aforementioned type with properties that exhibit good sealing, shear strength and mechanical load-bearing capacity are known as clay sealing sheets, such as the bentonite mat from Naue GmbH & Co. KG, and are described in EP 0 278 419 B1.

DE19956783A1 discloses a mat designed for covering carcasses, which was developed from the bentonite mat described in EP 0 278 419 B1. In this modified mat, by using a virucidal or bactericidal powder instead of the sealing powder (e.g., bentonite), a mat is proposed which effectively prevents the escape of active microorganisms from the burial site by means of a chemical-biological effect. The mat developed in this way therefore proposes a way of providing a chemical-biological barrier against microorganisms instead of sealing by means of swelling by using appropriate virucidal/bactericidal fillers. This represents a special mat suitable for the specific purpose of covering carcasses and the associated microbial hazard, but which cannot be used well for other purposes.

DE60203517T2 discloses a further floor mat based on the technology known from EP0278419B1. The aim of this floor mat is to ensure that the bentonite arranged in the intermediate layer can penetrate into the hollow and intermediate spaces in the neighbouring floor area and only swell there. This is intended to fill these cavities and gaps. To achieve this, the top layer of the floor mat should dissolve on contact with the floor due to the influence of water. The technology of this floor mat therefore turns away from the principle of the floor mat originally described in EP0278419B1 with a swelling and compacting function of the bentonite within the intermediate layer and instead strives for a rapid dissolution of the top layer so that the bentonite can move out of the intermediate layer into the hollow and intermediate spaces in the neighbouring soil before it begins to swell and then swell there. This soil mat is therefore suitable for special applications in which a soil layer that is basically made up of sealing soil materials but has cavities and gaps is to be sealed by sealing these imperfections. It is not suitable for other general sealing applications due to the rapid dissolution of the top layer required for this.

Such well-known geosynthetic mats are installed for temporary or permanent sealing, for example to protect thin-layer plastic films, as an element with a separating function or to stabilise soil layers or surfaces. However, in some applications with morphologically variable geometry, disadvantageous effects occur in the long term from an environmental point of view. For example, when such geosynthetic mats are used permanently, sections of the geosynthetic mat can be separated by erosion processes and transported to other locations by wind or water currents and then cause pollution in an undesirable place. When such geosynthetic mats are used temporarily, in some cases the geosynthetic mat can be removed from the ground in isolation and then disposed of. In many cases, however, such isolated removal is not possible because layers of soil adhere to the geosynthetic mat or the geosynthetic mat is damaged during removal. In such cases, a large amount of soil is often removed and the entire removed volume must then be disposed of. Due to the synthetic components in this removed volume, disposal falls into high pollutant classes and is correspondingly expensive.

### SUMMARY OF THE INVENTION

The invention is based on the task of providing a geosynthetic mat which overcomes these aforementioned disadvantages and at least fulfils, preferably exceeds, the necessary mechanical properties and sealing properties of previously known geosynthetic mats. This problem is solved according to the invention with a geosynthetic mat of the type mentioned in the introductory portion, in which the top cover layer and/or the bottom cover layer consist of a biodegradable material or comprise a biodegradable material, the peel strength at a predetermined point in time after the start of the biodegradation process being characterised by a residual peel strength which is formed by the square of a quotient of a reduced peel strength which the top and bottom cover layers and the connecting structure have at the predetermined point in time, to an initial peel strength exhibited by the upper and lower cover layers and the connecting structure before the start of a biodegradation process, wherein the residual peel strength is determined in a composting test by completely placing the geosynthetic mat in compost and composting in a temperature range above 25° C. and below 65° C. up to the predetermined time and measuring the peel strength in a peel test before insertion and at the predetermined time after removal from the compost or in a marine incubation test, with the following environmental conditions: temperature 30° C. +/−2° C.; aerobic conditions in seawater with a salt content of 3.5 wt.-% +/−1 wt. % and measurement of the peel strength in a peel test before insertion and at the predetermined time after removal from the seawater, and the swelling behaviour is characterised by a degree of swelling, which is formed by the quotient of the volume of the filler layer material including the water absorbed therein at the predetermined point in time to an initial volume of the filler layer material before the start of swelling, wherein the degree of swelling is determined by completely immersing a layer of filler layer material in a water bath and loading the layer of filler layer material with a pressure of 4.5 N/m². According to the invention, the geosynthetic mat has a swelling/degradation ratio which is formed from the degree of swelling divided by the residual peel strength, is in a range between 1 and 5 within the first week after the simultaneous start of the swelling process and the biodegradation process and is in a range between 1.5 and 25, preferably in a range with a lower limit of 2 and/or an upper limit of 15, within each predetermined point in time from the beginning of the second to the end of the third month after the start of swelling and degradation.

The invention is based on the following findings: In principle, the invention pursues the approach of at least partially, preferably completely, replacing the synthetic components of the geosynthetic mat, which were unavoidably used in particular in previous geosynthetic mats to provide the upper and lower cover layers and the connecting structure, with biodegradable materials, in that the upper and lower cover layers and the connecting structure comprise a biodegradable material or consist of such a biodegradable material. In the context of the invention, a biodegradable material is to be understood as a material which, under the typical environmental conditions in a soil installation position, i.e., in a moist environment of a soil layer, which may consist of the main constituents of soil, sand, clay, and mixtures of these typical soil layer constituents, decomposes in a short or medium-term period, by which is meant a period of a few weeks to a few months, up to two years or several years, e.g., up to 10 years. This is understood to be a period of a few weeks to a few months, up to two years or several years, e.g., up to 10 years, decomposes in a biological, chemical, or biochemical process and is thereby converted into components that are harmless to the environment.

The relevant reduction in peel strength according to the invention due to this biodegradation process is determined according to the invention in a composting test; this can be done, for example, by
a soil composting test with the following environmental conditions: Temperature 50° C. +/−5° C.; thermophilic conditions according to ISO 16929, or
by a marine incubation test, with the following environmental conditions: ; temperature 30° C. +/−2° C.; aerobic conditions in seawater with a salt content of 3.5 wt. % +/−1 wt. %;
   be characterised. It is to be understood here that the material used according to the invention has, in particular, a biodegradability according to the aforementioned soil composting test if it is intended for a soil layer sealing beyond a flowing or standing body of water and a biodegradability according to the aforementioned marine incubation test if it is intended for a soil layer sealing in a body of water or at the bottom of a body of water. The peel strength of a biodegradable material is determined over the biodegradation period in such a way that the geosynthetic mat is stored under the aforementioned environmental conditions of one of the two suitable tests for several different specific periods of time and is subjected to a peel test after this period of time, for example a drum peel test according to DIN 53295 or a peel test according to DIN EN 28510-1:2014 EN or according to ASTM D6496, in order to determine a course of the peel strength over time.

In particular, a composting environment in accordance with section 5.1 of DIN EN ISO 16929:2018-04 can be provided, i.e., an environment with the following conditions for carrying out the composting test:
the geosynthetic mat is placed in fresh biowaste with a natural, ubiquitous microbial population, so that this biowaste covers the geosynthetic mat on both sides with a thickness of at least 30 cm. thickness on both sides,
Temperature, pH value, moisture content and gas composition are monitored,
the composting test is carried out in a container that is large enough for natural self-heating to take place; an air supply system ensures sufficient and uniform fumigation,
of the container can be carried out in a climatic chamber with a constant chamber temperature,
If the compost reaches temperatures above 65° C. during the spontaneous thermophilic phase, the diversity of microorganisms can be reduced.
To restore the full range of thermophilic bacteria, the compost can be inoculated again with mature compost (about 1% of the total initial mass of biowaste) of recent origin (maximum 3 months old).

For the composting test, a homogeneous biowaste of the same age and origin is used, which is reduced to a maximum particle size of 50 mm by shredding or sieving. Depending on the type of waste, 10%-60% of a filler consisting of structurally stable components such as wood chips or bark with a particle size of 10 mm to 50 mm is added. The biowaste must fulfil the following criteria:
the C/N ratio of the mixture of fresh biowaste and filler is between 20 and 30, it can be equalised with urea if necessary,
the moisture content is more than 50% by mass, but there is no free water
the loss on ignition of the dry residue is greater than 50% by mass,
the pH value is above 5.

In addition to the peel strength, the swelling behaviour is also taken into account as a property of the geosynthetic mat according to the invention and the properties are set in relation to the peel strength. According to the inventors' knowledge, the pure degree of swelling cannot be used as a characteristic parameter for the desired long-term sealing properties of the geosynthetic mat for many applications, because the degree of swelling does not sufficiently reflect the desired compaction properties of the centre filling layer. Instead, the middle filler layer is formed or characterised with a degree of swelling, which describes the increase in volume under a constant pressure, which is realised in the test as contact pressure on the material layer, for example by a plate or disc with a corresponding weight.

It should be understood that the degree of swelling is taken into account for at least the first month and the following two months. In principle, the degree of swelling can also be taken into account over a longer period of time, which results in a good coordination of the properties, especially in the case of slowly swelling middle filling layers. For some materials, it must be taken into account that they already undergo initial swelling when stored in air, for example because these materials come out of the production process very dry and water-absorbent. In such cases, it should be understood that the materials are only used in the swelling behaviour test according to the invention under realistic conditions of intermediate storage in air and the swelling that occurs in the process, in order to avoid falsification of the results due to unrepresentative initial effects that could otherwise occur in the first hours or first days of the swelling test.

A decisive factor for the fulfilment of the functions of the geosynthetic mat is, on the one hand, that the upper and lower cover layers and the connecting structure always maintain sufficient counterpressure against the swelling of the middle filling layer, which leads to sufficient compaction of the middle filling layer and thus to the closure of the pores in the middle filling layer, particularly in the first few months. This achieves the necessary tightness and can then be maintained over a long period of time, especially after the swelling has asymptotically approached a maximum degree of swelling and the biodegradation has progressed to such an extent that the peel strength is significantly reduced or close to zero.

On the other hand, in many applications it is important that the geosynthetic mat provides the mechanical properties at all times after its installation that prevent it from slipping if it is installed on a slope. According to the inventors, an initially low reduction of the peel strength in relation to the swelling is decisive for this in order to maintain the shear strength through the biodegradable structures in an early phase in which no stabilising function of the middle filling layer has yet developed.

The period of time within which the desired properties, characterised by the swelling/degradation ratio, must be present can range from a few weeks to one or two years from the start of swelling and biodegradation.

Although the use of such biodegradable materials can, in principle, reduce or completely avoid the problem of pollutant dispersion or pollution after the removal of such a geosynthetic mat, the use of such biodegradable materials is not possible, that the sealing effect of the geosynthetic mat is generally not achieved due to biodegradation, because the necessary counter-pressure is not or not sufficiently generated when the middle filling layer swells, resulting in excessive permeability of the geosynthetic mat after swelling, which does not achieve the desired sealing function. On the other hand, the biodegradation of the top layers and the connecting structure reduces the shear strength of the geosynthetic mat to such an extent that slipping of slope layers occurs if the geosynthetic mat is installed at an angle on a slope. The use of biodegradable geotextiles is therefore seen as critical or unsuitable in many applications with regard to the time requirements for the mechanical bonding effect and DIN EN 12225 specifies test criteria for geosynthetics in order to demonstrate general resistance to microbial degradation.

The geosynthetic mat according to the invention overcomes these problems by means of a swelling behaviour that is coordinated in time with the behaviour of the biological degradation. For this purpose, the composite of upper and lower cover layer and connecting structure is characterised according to a degree of residual peel strength which this composite exhibits due to a biological degradation rate after a certain biological degradation period, i.e., at a predetermined time after the start of the biological degradation process over a subsequent period of time. This residual peel strength thus characterises the composite of the two cover layers and the connecting structure in terms of how quickly its peel strength is reduced over time by the biodegradation process, i.e., it represents a curve that reflects the peel strength of the biodegradable material over the biodegradation period. The slope of the curve at any point in time can be defined as the degree of peel strength reduction. The further the biodegradation has progressed, the lower the degree of peel strength reduction; the faster the biodegradation takes place, the steeper the curve of the degree of peel strength reduction falls over time and the faster the peel strength of the composite decreases as a result. The reduction in the degree of peel strength reduction can be caused by biodegradation of the top cover layer, the bottom cover layer and/or the connecting structure or by a reduction in the fastening strength of the connecting structure in the top or bottom cover layer.

On the other hand, the filling layer material of the middle filling layer has a swelling capacity, which is characterised by the water absorption and swelling capacity of the filling layer material. This swelling capacity is characterised by the degree of swelling lift, which describes the increase in volume of the filler layer material at a certain time after the start of swelling in relation to the dry volume of the filler layer material before the start of swelling under a compressive load of 4.5N/m² and produces a curve over time that reflects the increase in the volume of the filler layer material over the swelling time. The higher the degree of swelling, the greater the ability of the filler layer material to swell under load. It should be understood that the degree of swelling of the material is determined without limiting the swelling movement, i.e., the material can increase its water content or volume unhindered when determining the degree of swelling. In practice, this can be done by a force-controlled test or by placing a vertically freely movable plate with a weight of 4.5 kg per square metre on the filling layer material when determining the degree of swelling.

The swellable material of the centre filler layer and the biodegradable material of the upper and lower cover layer and, if applicable, also of the connecting structure are now such that the ratio between the degree of swelling of the swellable material and the residual peel strength of the composite of the upper and lower cover layer and connecting structure is between 1 and 5 over an initial period of one week and between 1.5 and 25, preferably between 2 and 15, from the beginning of the second month to the end of the third month. These two material properties of the centre filler layer, on the one hand, and of the mechanical composite surrounding this centre filler layer, on the other hand, which follow one another and are coordinated in terms of time, ensure that in the initial phase of swelling of the centre filler layer, the upper and lower cover layers and the connecting structure between these two cover layers can build up a sufficiently high mechanical counterpressure against the swelling pressure and maintain it over such a long period of time that sufficient compaction of the centre filler layer is achieved during this swelling process. In addition, it is achieved that the upper and lower cover layers and, if applicable, the connecting structure have biodegraded at a later point in time, at which this swelling is largely or completely completed, and as a result, a pollutant load can no longer occur when the geosynthetic mat is removed or when parts of the geosynthetic mat are moved due to erosion.

According to the inventors' findings, with sufficient homogenisation and reduction of the air void volume, the middle filling layer can develop an overall shear strength that is at least in the range of the shear strength of the geosynthetic mat immediately after installation, i.e., with a non-swollen middle filling layer and initial peel strength of the composite of the upper and lower cover layers and the connecting structure, or even exceeds this. This reliably prevents the risk of the slope slipping due to an unstable layer level in the form of the geosynthetic mat.

The geosynthetic mat according to the invention achieves a sufficiently high impermeability due to this composition and the ratio of the material properties with regard to the swelling behaviour of the middle filling layer and the degradation of the mechanical properties of the upper and lower covering layer due to the achievable compaction, but at the same time avoids the risk of the slope slipping and thus provides the desired hydraulic and mechanical properties in the medium and long term without the associated pollutant load. The geosynthetic mat according to the invention can therefore be installed without the risk of local environmental pollution and environmental hazards resulting from erosion and transport to other locations, provided that the middle filling layer comprises or consists of correspondingly environmentally compatible materials, and can be removed and disposed of cost-effectively in the event of temporary use.

The ranges of the ratio between the degree of swelling and the residual peel strength, which are maintained within the first three months, achieve a balanced development of the impermeability of the geosynthetic mat due to the swelling and the mechanical strength provision for the soil layer, even when installed on a slope and exposed to corresponding shear forces.

It is particularly preferable if the swelling/degradation ratio within the first week after the simultaneous start of the swelling process and the biodegradation process from the third day is in a range between 1.2 and 5. A particularly preferred swelling-degradation ratio in the first week for the installation of the geosynthetic mat with an overlying weighted soil layer is 1.25 to 4, preferably 1.25 to 3. A particularly preferred swelling-degradation ratio in the first week for the installation of the geosynthetic mat without an overlying soil layer is 1 to 4, preferably 1.2 to 3. In principle, the invention can preferably be realised for different installation situations in such a way that the swelling-degradation ratio in the first week from the third day is in a range which has a lower limit of 1, or 1.25 or 1.5 or 2 and which has an upper limit of 1.75 or 2 or 4 or 6.

From the beginning of the second to the end of the third month after the start of swelling and degradation, the swelling/degradation ratio is preferably in a range between 1.75 and 20, preferably in a range with a lower limit of 1.75 or 2 or 2.5 or 3 and/or an upper limit of 25 or 20 or 15 or 10.

It is preferable if the swelling/degradation ratio from the third month to the end of the twelfth month after the start of the swelling process and the biodegradation process is in a range between 2 and 50, preferably in a range with a lower limit of 3 and/or an upper limit of 30. With such a longer period of time, a long-term swelling and degradation process of the geosynthetic mat is recorded and the properties of the geosynthetic mat are such that optimum swelling and degradation behaviour is achieved over this longer period of time.

According to the inventors' findings, various effects can be realised advantageously through such a coordinated reduction in peel strength on the one hand and swelling on the other. For example, a strong increase in weight and volume regularly occurs at the beginning of the swelling process and at this time a high counterpressure against the swelling pressure is required in order to achieve the densest possible structure in the centre filler layer. The swelling of the middle filler layer also causes a compaction and mechanical stabilisation there, which on the one hand results from the swelling under counter pressure itself, which can be achieved with many materials that can be used for swellable middle filler layers, but also results in a stabilised middle filler layer through a chemical process. For example, a phyllosilicate contained in the middle filler layer can transform into another phyllosilicate during the swelling process, e.g., sodium bentonite can transform into calcium bentonite, thereby providing greater strength and stability against shear forces from the middle filler layer itself. This conversion process in the middle filler layer therefore makes it possible to reduce the peel strength of the stabilising top layer and connecting structure as the degree of swelling increases, until the top layer and connecting structure are completely broken down at a later point in time.

A typical example of this are centrefill layers that contain a mineral mixture known as bentonite with the main component montmorillonite in powder or granular form or consist of this mineral mixture. This mineral mixture can change from the initial state, which contains sodium bentonite components, to a swollen state, which contains calcium bentonite components converted from it, and increases in shear strength in the process. According to the inventors' findings, the calcium ions required for ion exchange are often already contained in sufficient quantities in the bentonite, and additional quantities are always present in the surrounding soil, which can accelerate the process. Over time, the ion exchange from sodium (monovalent) to calcium (divalent) then takes place. The ambient conditions determine how quickly this process takes place.

It is particularly preferable if the degree of swelling is greater than 1.25, preferably greater than 1.5 or 2, one week after the start of the swelling process and/or the degree of swelling is greater than 1.5, preferably greater than 2 or 3, one month after the start of the swelling process, and/or the residual peel strength three months after the start of the swelling process is less than 0.95, preferably less than 0.9 or 0.8 and/or the residual peel strength twelve months after the start of the swelling process is less than 0.9, preferably less than 0.75 or 0.5. In principle, swelling behaviour is to be understood as meaning that the filler layer swells to a relevant extent over time and biodegradation behaviour is to be understood as meaning that the peel strength decreases to a relevant extent over time. According to this further development, not only is the ratio of swelling and biodegradation set in a certain range, but the swelling behaviour and the reduction in mechanical strength due to biodegradation are also each isolated in an advantageous value range that achieves favourable swelling and appropriate biodegradation over time. For many applications, rapid swelling for the purpose of creating a seal is initially important, whereas biodegradation can and should preferably take place over a longer period of time.

It is particularly preferable if the connecting structure comprises a needling between the top and bottom cover layers or is formed by such a needling. In the case of needling, several individual fibres are pulled from this top layer through the middle filler layer by piercing the top layer with a barbed needle serving as a tool and hooked into the opposite top layer. Preferably, such needling can be carried out if the pierced top layer and/or the opposite top layer is designed as a nonwoven layer, i.e., as a layer with a disordered fibre structure from which fibres can be pulled out during the needling process and can be anchored in the opposite layer in order to form the connecting structure. However, needling is also possible if the anchoring top layer is formed with ordered fibre structures, for example knitted, crocheted or woven top layers, whereby needling preferably always starts from a nonwoven layer as the uppermost top layer, as the fibres in a nonwoven layer have good mobility perpendicular to the layer plane. Needling can be used in particular to provide a connecting structure which connects the top and bottom cover layers to one another at a large number of points distributed over the surface of the geosynthetic mat and spaced apart from one another, thereby achieving a connection between the two cover layers which acts virtually over the entire surface of the top and bottom cover layers and can therefore act particularly effectively against swelling pressure and shear forces. If the connecting structure, i.e., in particular the top layer pierced to create the needling, comprises fibres made of a thermoplastic (e.g., PLA, PBS, PBAT), the fibres can be additionally anchored on the back of the second top layer by melting and thus increase the initial internal shear bond of the geosynthetic mat. This can be done, for example, by means of a flame bar, which melts the fibre portions protruding outwards from the second top layer, causing them to form small nodules that prevent or hinder the fibres from being pulled out of the second top layer in the direction of the first top layer.

It is even more preferred if the upper and/or the lower cover layer and/or the connecting structure comprises fibres of the biodegradable material or is formed by such biodegradable fibres. By using fibres made of a biodegradable material, good strength, and the possibility of needling can be achieved on the one hand, and on the other hand such fibres can be biodegraded particularly well in a targeted manner, thereby providing the desired ratio of degree of swelling lift and degree of residual peel strength.

It is still further preferred if the biodegradable material of the top cover layer and the bottom cover layer is different from each other, or the biodegradable material of the top cover layer and the bottom cover layer is the same. According to this embodiment, in a first embodiment, the biodegradable material of the top and bottom cover layers is different, which can be advantageous in certain installation situations and soil structures in order to adapt the geosynthetic mat to local requirements on the top and bottom surfaces. In contrast, the second alternative is advantageous in many applications, in which the biodegradable material of the top and bottom cover layers is the same, i.e., the two cover layers are made of the same material. This embodiment enables a harmonious, similar degradation behaviour of the top and bottom cover layers, a favourable selection of connecting structures between the similar materials and is therefore well suited for many applications.

According to a further preferred embodiment, it is provided that the biodegradable material of the connecting structure is different from the biodegradable material of the top cover layer and/or the bottom cover layer, or the biodegradable material of the connecting structure is the same as the top cover layer or the bottom cover layer. In these two preferred embodiments, too, the biodegradable material of the connecting structure may again be different from that of the upper and/or lower cover layer in certain installation situations, for example if a particularly high shear strength or a shear strength acting over a long period of time is required, in order, for example, to achieve a slower biodegradation behaviour of the connecting structure compared to the cover layers or one of the cover layers. On the other hand, in many common installation situations, it is advantageous if the biodegradable material of the connecting structure is the same as that of the upper or lower cover layer or both cover layers, thereby achieving production advantages due to the similarity of the materials.

It is further preferred if the top and/or bottom cover layer comprises a non-woven layer of the biodegradable material or is formed by such a non-woven layer. If the top layer is formed as such a non-woven layer or comprises such a non-woven layer, this allows, on the one hand, a well adhering support and shear force transfer from surrounding soil layers into the geosynthetic mat, since a non-woven layer achieves a sufficient shear force transfer to adjacent soil layers due to its surface structure. A fleece layer is also well suited for needling, as explained above, and can therefore enable the formation of an efficient connection structure. A fleece layer is a fibre layer in which the fibres are present in a random order and which has medium-length to continuous fibres in the range of approx. 6 cm to several metres or more. The nonwoven layer can preferably consist of fibres that have at least two, preferably more, different fibre thicknesses, whereby a different fibre thickness is to be understood as a difference of at least 100%, i.e., a difference in which fibres with a first diameter and fibres with a second diameter that is twice as large as the first diameter are included in the nonwoven layer. Using such nonwoven layers with inhomogeneous fibre thicknesses, the biodegradation behaviour can often be well adapted to the swelling behaviour of the middle filler layer.

It is still further preferred if the upper and/or the lower cover layer comprises an ordered textile layer, in particular a knitted, woven or crocheted textile layer of the biodegradable material or is formed by such a textile layer. According to this embodiment, an upper or lower cover layer with an ordered structure of the fibres is provided, whereby a higher strength of the cover layer in the longitudinal and transverse direction is achieved, in particular in comparison to non-woven layers, and furthermore a lower liquid permeability can often be achieved if a close-meshed arrangement of the fibres in the textile layer is realised.

It is even more preferable if the centre filler layer comprises a mixture of the swellable material, such as a bentonite powder, in particular sodium bentonite, and a non-swellable aggregate, such as an inorganic bulk material, for example a granulate, in particular sand, glass granulate, chalk, or coal granulate, or is formed by such a mixture. According to this embodiment, a mixture of swellable material and non-swellable aggregate is arranged in the centre filling layer. Both materials are present in the form of a bulk material and are preferably homogeneously mixed together. According to the inventors' knowledge, the addition of such an aggregate can significantly increase the load-bearing capacity of the middle filler layer against shear forces and thereby favourably influence the mechanical properties of the geosynthetic mat after extensive or complete biodegradation of the two cover layers and the connecting structure in such a way that installation and retention on steeper slopes is also possible. The mixture can be designed in such a way that it has a proportion of at least 20% by weight of swellable material and at least 20% by weight of aggregate or at least 30% by weight, 40% by weight of swellable material and at least 30% by weight or 40% by weight of aggregate.

It is even more preferable if the centre filler layer comprises a hardening or hardening liquid, in particular a hard oil such as linseed oil or tung oil, wherein the liquid is preferably only present in a partial area such as a partial cross-section of the centre filler layer. The addition of such a curing or curing-inducing liquid can further increase the mechanical resilience, in particular to shear stresses on the centre filler layer or to erosion effects acting on the surface, thereby compensating for the biodegradation of the cover layers and the connecting structure. A curing liquid is a liquid that changes from a liquid to a solid state, for example by polymer cross-linking or by evaporation of solvent components. A curing liquid, on the other hand, is a liquid that reacts with other components of the filler layer and thereby promotes curing of the filler layer. The liquid can be distributed over the entire centre filler layer and the entire cross section of the centre filler layer, but it can also be applied only in partial areas, for example selectively, in grid tracks, longitudinal tracks or transverse tracks of the geosynthetic mat. The liquid can also only be present over a partial cross section of the centre filler layer, for example only in a surface area of the centre filler layer or in a central area of the cross section of the centre filler layer.

It is further preferred if the geosynthetic mat is further formed by an upper barrier layer arranged adjacent to the upper cover layer and/or a lower barrier layer arranged adjacent to the lower cover layer, each barrier layer being formed by a film, in particular by a film made of a biodegradable material, wherein preferably the upper barrier layer is arranged between the upper top layer and the centre filler layer, the lower barrier layer is arranged between the lower top layer and the centre filler layer, the upper top layer is arranged between the upper barrier layer and the centre filler layer, or the lower top layer is arranged between the lower barrier layer and the centre filler layer. Such a barrier layer can prevent swelling-accelerating or swelling-impeding substances from penetrating into the middle filling layer from layers of earth adjacent to the geosynthetic mat, thereby having an unfavourable and unpredictable influence on the swelling behaviour of the middle filling layer. A barrier layer of this type ensures that a planned slow swelling behaviour from the rising soil moisture or targeted irrigation is made possible that matches the biological degradation behaviour of the connecting structure and the cover layers. Such a barrier layer can be provided by a polyethylene film, but films made of biodegradable plastics can also be used for the barrier layer; in particular, biodegradable materials can be used for the barrier layer that match the top or bottom cover layer. The barrier layer can be applied during the manufacturing process of the geosynthetic mat in the form of a coating (inline extrusion) or applied as a finished film by lamination, bonding, or similar.

According to a further preferred embodiment, it is provided that the biodegradable material of the top cover layer, the bottom cover layer, and/or the connecting structure comprises fibres or consists of fibres, which comprise a fibre core strand of a first biodegradable material and a fibre core strand sheath of a second biodegradable material enveloping the fibre core strand, wherein the first biodegradable material has a first biodegradation rate which is higher than a second biodegradation rate of the second biodegradable material. According to this embodiment, the upper and lower cover layer and/or the connecting structure comprise fibres which are composed of a fibre core strand and a fibre core strand sheathing, wherein the fibre core strand and the fibre core strand sheathing are composed of two materials which have different rates of biodegradation. According to the inventors, this design of the fibres achieves a significant advantage in that the degradation behaviour of the fibre and thus its reduction in tensile strength takes place discontinuously, i.e., with two successive different degradation phases. In a first phase, the fibre core strand sheathing is initially biodegraded, whereas the fibre core strand is not yet subject to any or only slight biodegradation because it is still protected by the fibre core strand sheathing from the influences that would cause such biodegradation, such as the effects of radiation and liquid. The fibre core strand therefore retains its mechanical properties completely or almost completely in this first phase, so that if the mechanical properties of the fibre are dominantly characterised by the mechanical properties of the fibre core strand, the fibre does not or hardly loses any mechanical properties in this first phase of biodegradation of the fibre core strand sheathing. Only after degradation of the fibre core strand sheath is the fibre core strand then biodegraded and consequently the mechanical properties of the fibre are significantly reduced. The fibre constructed in this way therefore shows an initially very delayed reduction in its mechanical properties, which then increases at a certain point in time. This is advantageous for the geosynthetic mat according to the invention in many applications, since sufficient mechanical strength can be provided by the cover layers and the connecting structure over a certain period of time, which can, for example, correspond to the typical swelling behaviour or the typical conversion behaviour of a middle filling layer, but after this period of time a rapid biological and complete degradation of the cover layers and the connecting structure with a corresponding reduction in mechanical strength is then achieved.

It is further preferred if the first biodegradable material comprises a natural fibre such as coconut fibre, jute fibre, hemp fibre, bamboo fibre, or flax fibre or a biodegradable synthetic fibre of PBS, PBAT, PLA or a polymer blend of at least two of these materials, or that the biodegradable material comprises a mixture of fibre cores of natural fibres and synthetic fibres, preferably with the proportion by weight of the synthetic fibres being greater than 30%, in particular greater than 50%. The use of these fibre materials or mixtures of these fibre materials has proven to be particularly suitable for many applications in order to achieve the mechanical strength and biodegradation rates required for a geosynthetic mat with a swellable material in the middle filling layer.

It is even more preferable if the second biodegradable material comprises a cellulose-based plastic, a starch blend, lyocell, succinic acid (PBS), a biodegradable polyester such as polybutyrate adipate terephthalate (PBAT), or polylactic acid (PLA). These materials have proven to be particularly suitable as coating materials, as they exhibit sufficiently slow biodegradation behaviour, but can also be easily applied as a coating in liquid form. It should be understood that the fibres in the top layer or the connecting structure can be designed in such a way that they have already been coated before the fibre material is processed into the top layer, i.e., the top layers have been made from coated fibres. Alternatively, it is also possible to produce the cover layers from uncoated fibres, i.e., only from the fibre core strands, and then to coat the cover layer as a whole with the second biodegradable material in order to thereby also envelop cut fibre ends and to achieve a strengthening of the cover layer through bonding effects at intersections of fibres by the second biodegradable material.

It is even more preferable if the medium-fill layer has a permeability of between 1×10−5 and 1×10−9 m/s. According to this embodiment, the geosynthetic mat is provided with a centre filler layer that has a permeability that is initially insufficient in the production state prior to installation in order to achieve reliable sealing of soil layers. According to the inventors, such permeability can initially be tolerated in many applications or is even desirable in order to achieve seepage of the geosynthetic mat in an initial phase after installation. During this seepage, particles contained in the water that seeps through the geosynthetic mat are deposited in the middle filling layer and lead to a compaction and sealing of the middle filling layer in the manner of a clogging filter, i.e., a colmation process takes place that corresponds to the build-up of a filter cake in or on the middle filling layer. This enables a favourable sealing effect to be achieved at a particularly high sealing level with a particularly low permeability of the geosynthetic mat. In the first phase, the geosynthetic mat only acts as a seepage barrier and only achieves its final impermeability after a certain seepage phase, which it then retains. According to the inventors, this structure of the geosynthetic mat is particularly suitable for creating a seal in beds of liquid-carrying flows, such as streams and rivers, utilising the fact that the liquid in the stream or river carries along corresponding particles which can act as a seal. According to one aspect of the invention, this also includes a geosynthetic sheet in which the middle filling layer consists of a material with only a very low swelling capacity or a non-swelling material—i.e., a material with a swelling degree of lift of 1 over the entire installation period. For example, a middle filler layer made of sand or other pourable mineral materials can be used for such a sealing effect through colmation.

A further aspect of the invention is a geosynthetic web comprising at least one layer comprising fibres or formed by fibres, wherein the fibres comprise a fibre core strand of a first biodegradable material and a fibre core strand sheath of a second biodegradable material enveloping the fibre core strand, wherein the first biodegradable material has a first biodegradation rate and the second biodegradable material has a second biodegradation rate which is different, in particular higher, than the first biodegradation rate of the first biodegradable material. For the purposes of the invention, a geosynthetic sheet, like a geosynthetic mat, is understood to be a structure which has dimensions in a longitudinal direction and a transverse direction which are many times greater than its thickness. A geosynthetic mat and a geosynthetic sheet can in turn have dimensions in the longitudinal direction in particular that are a multiple of their dimensions in the transverse direction, i.e., they can be significantly longer than they are wide. Geosynthetic mats and geosynthetic sheets are therefore typically transported in a rolled or folded state and then unrolled or unfolded at an installation site in order to be able to lay them lengthways. In the understanding of the invention, a geosynthetic mat is to be distinguished from a geosynthetic sheet by the fact that the geosynthetic mat has several layers, whereas a geosynthetic sheet can also have only a single layer, but may also have a multi-layer structure.

The geosynthetic sheet according to the invention is characterised in that it is formed from fibres which have at least a two-layer structure, or has such fibres. The fibres have a fibre core strand and a fibre core strand sheath covering this fibre core strand. The fibre core strand and fibre core strand sheath consist of two different biodegradable materials which have different biodegradation rates, i.e., are biodegraded in such a way that, under the same biodegradation conditions, the first material is biodegraded either faster or slower than the second material. Preferably, the second material has a biodegradation rate that is lower than the biodegradation rate of the first material, i.e., the second material biodegrades more slowly than the first material.

As previously in connection with the geosynthetic mat, which can also have fibres or a layer of fibres which are formed in at least two layers in such a way, a more favourable progression of the mechanical strength during the biodegradation of the fibres or layer made from the fibres can be achieved by such a fibre design, in particular in such a way that the fibres maintain a high mechanical strength over a longer period of time in a first phase, namely while only the fibre core strand is biodegraded. of the layer made of the fibres, in particular in such a way that the fibres maintain a high mechanical strength over a longer period of time in a first phase, namely while only the fibre core strand sheathing is biodegraded, whereas then, after degradation of the fibre core strand sheathing has taken place, the mechanical strength of the fibres decreases rapidly in a second phase when the fibre core strand is then degraded. It is to be understood that these properties and also the further embodiments thereof, which were previously explained in relation to the geosynthetic mat, are also applicable to the geosynthetic sheet and accordingly reference is made thereto.

According to a preferred embodiment, it is provided that the fibres in the layered sheet are present as an unordered structure, in particular as a non-woven layer, or are present as an ordered structure, in particular as a knitted, woven or crocheted textile layer. Accordingly, the special fibres of this geosynthetic sheet can be present as an unordered structure, for example as a non-woven layer, resulting in the properties and advantages described above, which also arise in connection with the geosynthetic mat described above. Alternatively, the fibres can also be processed as an ordered structure, i.e., knitted, woven or knitted or otherwise arranged in a directed manner, whereby an ordered structure, as also previously understood for the geosynthetic mat, is to be understood as a structure which has a regularly repeating geometric pattern of the course of the fibres, typically along a straight line direction or two straight, intersecting directions. With regard to the ordered structure, reference is also made to the properties and advantages previously explained for the geosynthetic mat.

The geosynthetic sheet can then be further developed by coating the fibres circumferentially and endwise with the fibre core strand coating, in particular by producing the layered sheet in a process in which, in a first step, a fibre core layer is produced from fibre core strands and, in a subsequent second step, the fibre core strands of the fibre core layer are coated with a coating material. Such an embodiment with a circumferential and end-face coating of the fibre core strand with the fibre core strand coating can be achieved in particular by first producing the layered ply from the fibre core strands, for example by processing it into a nonwoven or weaving or knitting it, and then coating the pre-produced layer of fibre core strands with the fibre core strand coating, for example by immersing it in a liquid or wetting it with a liquid in a spraying or coating process, thereby coating the fibres on all sides. In order to achieve the biodegradation properties in the desired manner, this is advantageous and therefore preferable to processes in which the fibres are completely pre-produced and then processed, because in this processing method, the end-face fibre core strand cross-section ends are exposed by the necessary separation of the fibres and would therefore be accessible to rapid biodegradation.

A further aspect of the invention is a geosynthetic mat of the structure and functionality described above, in which the upper and/or the lower cover layer comprises a geosynthetic sheet of the structure and functionality described above or is formed by such a geosynthetic sheet. As explained above, the properties of such a geosynthetic sheet with the two-layer fibres contained therein can be used particularly advantageously for the geosynthetic mat according to the invention.

A still further aspect is the use of a geosynthetic mat of the construction method described above or a geosynthetic sheet of the construction method described above for producing a sealing layer in the ground or at the bottom of a body of water. As already explained above, the geosynthetic mat according to the invention and the geosynthetic sheet according to the invention are particularly well suited for producing a sealing layer in the ground and furthermore well suited for producing such a sealing layer at the bottom of a body of water. The balanced properties of providing a mechanical peel strength for a first phase of swelling of the middle filling layer are particularly effective and can achieve a secure seal, whereas the biodegradation of the cover layers and the connecting structure and any additional barrier layer provided can significantly reduce or completely avoid environmental pollution when removing the geosynthetic mat or geosynthetic sheet or in the event of erosion-induced discharge of parts of the geosynthetic mat or sheet.

The use can be advantageously continued by rolling out the geosynthetic mat in a first step and impregnating the geosynthetic mat with a liquid, in particular with a hard oil, in a subsequent second step. In this method of use, the geosynthetic mat or geosynthetic sheet is first almost completely prefabricated by producing the layers, arranging them in relation to each other and joining them together and then rolling up the geosynthetic mat or sheet prefabricated in this way so that it can be transported. Once it has been transported to the installation site, the geosynthetic mat or geomembrane is then rolled out in order to lay it and then wetted at the installation site with a liquid that influences its further mechanical and/or biological behaviour. This impregnation of the geosynthetic mat or geomembrane only at a second point in time, which follows the time of production of the geosynthetic mat or geomembrane, prevents the properties of the geosynthetic mat or geomembrane from changing during any storage or transport due to an impregnation with the liquid that has already taken place, but instead ensures that the desired functional and structural property influences by the liquid only begin at the installation site, following the wetting with the liquid that takes place there.

It should be understood that this impregnation can also consist in the coating of fibre core strands which have been processed in a pre-production process to form a cover layer, a connecting structure or the like in the geosynthetic mat or sheet and which are then provided with an additional coating on site in order to favourably influence the biodegradation behaviour and the mechanical properties.

The wetting/impregnation can be carried out in particular in such a way that it is selected as a function of environmental conditions at the installation site, which have been measured beforehand, for example by adapting a layer thickness to such environmental conditions or by selecting the liquid with which the impregnation is carried out from several different available liquids or mixing them. The environmental conditions that can influence this selection or impregnation intensity are, for example, a moisture content of the soil, a pH value of the soil, a concentration of substances in the soil that accelerate or slow down the biodegradation process, the intensity of UV radiation at the installation site and other influencing factors. In principle, it should be understood that for these types of use with pre-wetting, the time from which the swelling-degradation ratio is determined and lies within the specified ranges must be determined from the time the geosynthetic mat is impregnated, even if the liquid used for impregnation may not yet trigger biodegradation.

According to a still further preferred embodiment of the use according to the invention, it can be provided that the geosynthetic mat is impregnated with a liquid at a first point in time before laying, which causes a pre-swelling of the centre filling layer, and is installed in an installation position at a subsequent second point in time at an installation location and swells in the installation position by supplying liquid, in particular from the surrounding soil. According to this embodiment, it is envisaged that the geosynthetic mat or sheet is impregnated with a liquid before it is laid, which causes the centre filler layer to pre-swell. Pre-swelling is to be understood here as a limited swelling in which the material of the centre filler layer does not yet exhaust its maximum swelling capacity, i.e., does not yet swell to its maximum, but only exhausts part of this swelling capacity. Such impregnation with a liquid for this pre-swelling can, for example, already take place during the production of the geosynthetic mat or geomembrane, but can also alternatively take place in such a way that the geosynthetic mat is produced at a first point in time and the geosynthetic mat is impregnated for pre-swelling at a second point in time, for example shortly before delivery or transport of the geosynthetic mat. the transport of the geosynthetic mat to the installation site, so that the effects of changes in the geosynthetic mat during any storage between the time of production and the time of transport are avoided. Pre-swelling can favourably promote and serve to positively influence the initial swelling behaviour of the geosynthetic mat immediately after installation in the first few days or weeks, thereby avoiding unfavourable structural changes or mechanical property changes.

The liquid with which the geosynthetic mat is impregnated at the first point in time may correspond to or be similar to the liquid that also causes swelling at the installation site, for example, it may consist of an impregnation with water. In other applications, however, the liquid with which the geosynthetic mat is impregnated at the first point in time may also be different from the liquid with which the geosynthetic mat is wetted at the installation site, i.e., it may in particular have a different composition or contain additives that favour pre-swelling, which also act, for example, in such a way that pre-swelling is promoted, but biodegradation is inhibited or prevented, in order to prevent premature biodegradation of the cover layers and the connecting structure by the impregnation at the first point in time.

It is then preferable for the geosynthetic mat to be brought into a transportable state after impregnation at the first point in time, in particular to be rolled up or folded for this purpose and then transported to the installation site. In principle, it is preferable to impregnate the geosynthetic mat uniformly at the first point in time before the geosynthetic mat is in a transportable state in order to avoid the geosynthetic mat being impregnated differently at different locations.

The use according to the invention can be further developed in the use of the geosynthetic mat for producing a sealing layer at the bottom of a body of water, or in the use of the geosynthetic mat for producing a seal in a soil layer, in that the geosynthetic mat is laid on the bottom of the body of water at a first point in time or is installed in the area of the bottom of the body of water or is installed in a soil layer and wherein the upper cover layer of the geosynthetic mat has an open porosity and, as a further improvement, the outer surface of the upper cover layer has an outwardly facing roughness structure and the geosynthetic mat is installed in a soil layer. and wherein the upper cover layer of the geosynthetic mat has an open porosity and, as a further improvement, the outer surface of the upper cover layer has an outward-facing roughness structure and the geosynthetic mat is laid on the bed of the body of water in such a way that the outer surface of the upper cover layer faces upwards, and wherein furthermore the middle filling layer has a permeability of between 1×10−5 and 1×10−9 m/s and that particles entrained in the body of water above the body of water are deposited in the pore structure, further favourably influenced by a reduced flow velocity and reduced drag stress due to the roughness structure, and migrate through the upper cover layer into the middle filling layer, so that particles from the water deposited in the middle filling layer and the upper cover layer form a sealing layer, which at a second point in time, which is after the biological degradation of the upper cover layer, form a supplementary sealing effect within the swollen middle filling layer and an additional sealing layer at the site of the degraded upper cover layer.

According to this advantageous use, the geosynthetic mat is used in such a way that the centre filler layer initially has a certain permeability value in a defined value range, thereby allowing the passage of liquid. This permeability is combined with an open porosity and consequently permeability of the top cover layer and preferably also of the bottom cover layer, further improved by an outward-facing roughness structure of the outer surface of the top cover layer, which can be provided, for example, by the typical roughness of a non-woven layer or an ordered structure of the cover layer produced by weaving, knitting, or warp knitting. This ensures that liquid flows through the centre filler layer in an initial phase after installation, allowing particles in the liquid to settle in the centre filler layer and the top or bottom cover layer, thereby reducing permeability. This flow through and the associated settling of particles from the liquid flowing through in the geosynthetic mat consequently causes a gradual sealing of the geosynthetic mat in this first phase after installation, which continuously changes to a state in which the permeability is reduced to such an extent that hardly any or no more flow takes place and the geosynthetic mat is sealed at this point. This sealing effect caused by particles at the installation site during an initial phase is known as colmation and can be used to advantage for the overall properties, particularly due to the structure of the geosynthetic mat. Due to the structure of the geosynthetic mat in this way and the use of colmation, it is not necessary for the middle filling layer to swell so much and to work with such a high counter-pressure against the swelling behaviour within the geosynthetic mat that the desired tightness is provided by this swelling behaviour alone. This relieves the demands on the peel strength of the upper and lower cover layers and the connecting structure and also makes it possible to design the middle filler layer in such a way that it only has limited swelling behaviour, for example by also providing the middle filler layer with additives that increase the shear strength of the middle filler layer. The embodiment and use according to the invention consequently makes it possible to provide a middle filler layer with increased shear strength, to reduce the mechanical requirements on the upper and lower cover layers and the connecting structure, also with regard to their biodegradation behaviour and the resulting peel strength, and at the same time to achieve a very low permeability in the permanent use of the geosynthetic mat.

It is particularly preferable if the geosynthetic mat is used in such a way that the quantity of particles carried in the body of water per volume of water is determined as particle quantity density before the geosynthetic mat is laid on the bottom of the body of water and the geosynthetic mat is designed in such a way that the swelling-degradation ratio and/or the degree of residual peel strength and/or the thickness of the upper covering layer is designed as a function of this particle quantity density, in particular such that the higher the particle quantity density, the smaller the swelling-degradation ratio is designed, the greater the degree of residual peel strength is designed and/or the smaller the thickness of the upper covering layer is designed. According to this embodiment, the properties of the body of water are determined before the geosynthetic mat is installed, in particular the quantity of particles carried in the body of water per volume of water, i.e., the particle density in the body of water. This can include the number of particles, but can alternatively or additionally also include the size of the particles that are carried in the body of water. The geosynthetic mat is then adapted depending on this determined parameter of the body of water in relation to the particle quantity, whereby this adapted design can consist of adapting the properties of the top cover layer and/or the properties of the middle filler layer in order to achieve an ideal colmation effect and ideally adapt the geosynthetic mat to this. For example, in bodies of water that carry a particularly large number of particles, a middle filler layer with a lower degree of swelling can be used in the geosynthetic mat than in bodies of water that only have a low particle density. The properties of the top cover layer can be adapted in the same way, i.e. in the case of bodies of water with a high particle density, for example, rapid biodegradation with a correspondingly high degree of peel strength reduction can also be used, as in this case a rapid sealing effect due to the colmation effect can be expected and consequently counterpressure against swelling of the middle filler layer does not play as great a role as in the case of bodies of water with a low particle concentration, which require such swelling behaviour for the geosynthetic mat to have a good sealing effect. Furthermore, the surface of the top layer can be adapted in terms of its roughness structure so that, depending on the water-specific flow conditions and drag stress on the surface of the mat, particles can be reliably deposited and embedded in the mat.

A further aspect of the invention is a method for producing a geosynthetic mat, comprising the steps of: providing a first geosynthetic layer, applying a middle filler layer of a filler layer material comprising a swellable material to the first geosynthetic layer, the filler layer material having a swelling behaviour, applying a second geosynthetic layer to the middle filler layer, connecting the first and second geosynthetic layers through the centre filler layer by means of a connecting structure, in particular by needling, in which a layer of a first biodegradable material is provided as the first geosynthetic layer and a layer of a second biodegradable material is applied as the second geosynthetic layer, wherein the upper and lower cover layers have, as a result of the bonding, a connection to one another characterised by a peel strength, which is characterised at the predetermined time after the start of the biodegradation process by a residual peel strength which is formed by the square of a quotient of a reduced peel strength, which the upper and lower cover layers and the connecting structure have at the predetermined time, to an initial peel strength, which the upper and lower cover layers and the connecting structure have before the start of a biodegradation process, wherein the residual peel strength is determined in a composting test by completely placing the geosynthetic mat in compost and composting in a temperature range which is above 25° C. and below 65° C. until the predetermined time and measuring the peel strength in a peel test before placing and at the predetermined time after removal from the compost, and wherein the swelling behaviour is characterised by a degree of swelling uplift, which is formed by the quotient of the volume of the filling layer material including the water absorbed therein at the predetermined point in time to an initial volume of the filling layer material before the start of swelling, wherein the degree of swelling is determined by completely immersing a layer of filler layer material in a water bath and applying a pressure of 4.5 N/m2 to the layer of filler layer material, and wherein a swelling/degradation ratio which is formed from the degree of swelling lift divided by the residual peel strength is in a range between 1 and 5 within the first week after the simultaneous start of the swelling process and the biodegradation process and is in a range between 1.5 and 25, preferably in a range with a lower limit of 2 and/or an upper limit of 15, within each predetermined point in time from the beginning of the second to the end of the third month after the start of swelling and degradation.

With regard to the manufacturing process, it should be understood that the properties of the geosynthetic mat with regard to the degree of residual peel strength and the degree of swelling and the resulting swelling/degradation ratio over time and its height can be as explained above with regard to the geosynthetic mat.

Furthermore, a specific roughness structure of the surface can be produced by applying a structural material with a degradation behaviour corresponding to that of the first or second cover layer or a third degradation rate, and needling the structural material with the geosynthetic layers. The method according to the invention can be used in particular to produce a geosynthetic mat with the properties described above and makes it possible to provide a geosynthetic mat which is suitable for the use described above at the installation site.

It should be understood that the steps carried out in the method preferably lead to the previously explained structural and functional properties and advantages of the geosynthetic mat according to the invention and enable the previously explained use. In this respect, reference is made to the previous explanation of the corresponding properties and advantages with regard to these process steps.

The method described above and the further development of the method according to the invention described above can preferably be further developed in such a way that the first and/or the second biodegradable material is in fibre form, in particular as fibres, which have a fibre core strand of a first biodegradable material and a fibre core strand sheath of a second biodegradable material, wherein the first biodegradable material has a first biodegradation rate which is higher than a second biodegradation rate of the second biodegradable material. According to this further development of the process, the first and/or the second biodegradable material is formed from fibres which have a two-layer structure, i.e., have a fibre core strand and a fibre core strand sheathing, wherein the fibre core strand sheathing can already be present before the respective layers or the connecting structure are produced from the fibres or can be applied subsequently in the production process or can also only be applied on site at the installation location. In this respect, reference is made to the previous explanation of corresponding fibres in use in the geosynthetic mat according to the invention or a corresponding geosynthetic sheet.

The process can be further developed by producing the first and/or second top layer from the fibre core strands in a first step and then coating the fibre core strands in the first and/or second top layer with the fibre core strand coating in a subsequent second step. According to this embodiment, the fibre core strand sheathing is only applied after the top layer has been produced from the fibre core strands, thereby achieving a comprehensive coating of the fibre core strands, including on any end-face cut edges. Reference is also made in this respect to the previous description.

It is even more preferable if the top and/or bottom cover layer, the centre filler layer or the entire geosynthetic mat is impregnated with a liquid, in particular with a hardening liquid such as a hard oil. This production step of impregnation with a liquid such as a hard oil can in turn take place directly during the production of the geosynthetic mat at the production site, but can also take place subsequently, for example immediately before the geosynthetic mat is transported to an installation site or after the geosynthetic mat has been transported to the installation site, for example when the geosynthetic mat has already been laid out. The previously explained advantages of delayed impregnation with the liquid also apply in this respect to the method according to the invention.

It is also preferable if a non-swellable aggregate, in particular sand, is also applied when the centre filler layer is applied. By applying a non-swelling aggregate, the swelling behaviour of the middle filler layer can be influenced, for example to promote the colmation effect, and the shear strength of the middle filler layer is increased, thereby improving the suitability of the geosynthetic mat for installation in shear-loaded installation situations, such as on slopes, which is particularly advantageous after biodegradation of the top and bottom cover layers and the connecting structure.

### BRIEF DESCRIPTION OF THE DRAWINGS

Preferred embodiments of the invention are explained with reference to the attached Figures. They show:

FIG. 1 is a schematic, perspective, partially cut and partially fanned-out representation of a geosynthetic mat according to the invention;

FIG. 2 is a cross-sectional longitudinal view of a second embodiment of a geosynthetic mat according to the invention;

FIG. 3 is a perspective, sectional view of a fibre for producing a geosynthetic mat according to the invention;

FIG. 4 is a second embodiment of a fibre for the production of a geosynthetic mat according to the invention in a longitudinal side view; and

FIG. 5 is a schematic diagram of the progression of peel strength and swelling over time of a geosynthetic mat according to the invention.

### DETAILED DESCRIPTION OF THE EMBODIMENTS

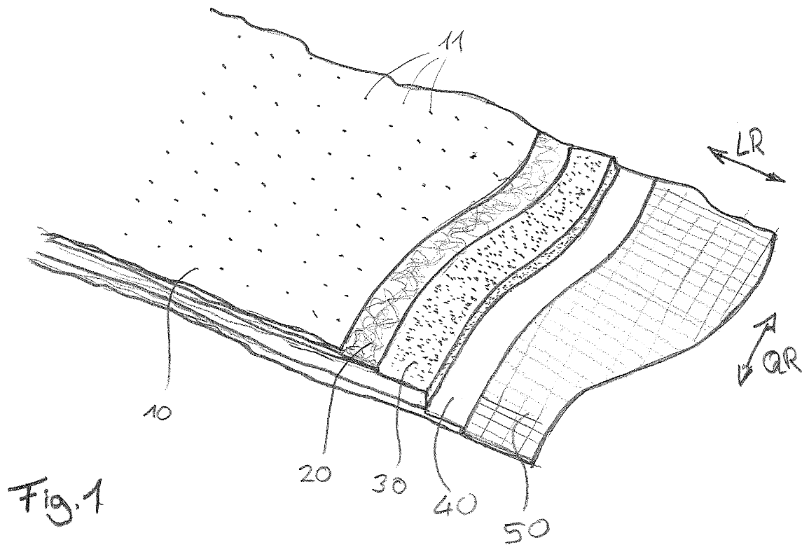

Referring firstly to FIG. 1, a preferred embodiment of the geosynthetic mat according to the invention is constructed from a total of five layers. The uppermost layer is a first sealing layer 10, which is made of a biodegradable plastic as a liquid-tight film and covers the upper surface of the geosynthetic mat as a fluid barrier.

An upper cover layer in the form of a non-woven layer 20 is arranged below and adjacent to this upper sealing layer 10. This non-woven layer 20 is made up of randomly laid fibres and typically has a thickness that is greater than the sealing layer 10, in particular three to ten times greater than the thickness of the sealing layer 10.

A middle filler layer 30 in the form of a layered silicate layer of sodium bentonite is arranged below and adjacent to the upper top layer 20. The thickness of this middle filler layer 30 is greater than the thickness of the nonwoven layer 20, typically by a factor of 5 to 20 greater than the thickness of the nonwoven layer 20. This middle filler layer 30 is composed of a mixture of sodium bentonite particles and sand particles and may be impregnated, for example with a linseed oil, depending on the application. This composition enables the middle filler layer 30 to initially exhibit a basic strength and groundwater impermeability and to further increase this strength and impermeability by swelling the sodium bentonite in the composition with surrounding moisture, such as soil moisture. This swelling process converts the sodium bentonite into calcium bentonite, which causes the middle filling layer to solidify. It should be understood that the middle filler layer 30 can also be composed in a different way and then also has an initial base strength and initial base density, which can be increased by swelling from surrounding moisture. For example, the middle filler layer 30 can be composed exclusively of a swellable material such as bentonite or a layered silicate, or aggregates other than sand can be used. Impregnation with linseed oil can be replaced or supplemented by other liquids such as hard oils or such impregnation can be dispensed with.

A second sealing layer 40 is arranged below the middle filling layer 30, which is designed in the same way as the first sealing layer 10. The first sealing layer 10 and the second sealing layer 40 prevent swelling-accelerating or swelling-inhibiting substances from the surrounding soil layers from entering the middle filling layer 30 immediately after installation of the geosynthetic mat, thereby adversely affecting the swelling behaviour.

Finally, a geotextile layer 50, which is composed of woven fibres, is arranged below and adjacent to the second sealing layer 40. The fibres in the geotextile layer 50 are thus aligned in an orderly manner, in this case in a rectangular grid pattern, and ensure good longitudinal and transverse load-bearing capacity of the geosynthetic mat.

The entire geosynthetic mat is fixed to each other by a needling 11 in the thickness direction, i.e., perpendicular to its longitudinal and transverse extension. The needling fixation comprises a large number of individual needling points, which are distributed over the entire geosynthetic mat and can, for example, be arranged in columns and rows or pseudo-randomly to one another. This needling connects the upper and lower cover layers over a large area and the composite of the upper and lower cover layers and needling therefore has a resistance to peeling of the upper cover layer or the lower cover layer from the composite, i.e., a peel strength.

Needling can be achieved by piercing a needle with barbs vertically through the geosynthetic mat, thereby taking fibres from the non-woven layer 20 and/or the geotextile layer 50 and pulling these fibres vertically through the geosynthetic mat. These fibres become entangled in the geotextile layer 50 and the non-woven layer 20 and can also become entangled in the sealing layers 10 and 40. This entanglement and looping can be additionally reinforced by welding or knotting in order to strengthen the fastening by needling. Instead of such needling, other methods can also be used to fix the layers in the geosynthetic mat to each other, for example the geosynthetic mat can be sewn, for example by sewing with a fibre in the same pattern as the needling and thereby passing the sewing thread vertically through the geosynthetic mat at the multiple points and thereby fixing and stabilising the layers to each other. For use in channels and bodies of water with the inclusion of colmation effects, layer 10 can be replaced by a superficial roughness structure and layer 40 can be omitted in order to achieve an initial flow.

It should be understood that the geosynthetic mat extends in a longitudinal direction LR and a transverse direction QR and, in particular, can be wound up along the longitudinal direction LR. The edges of the geosynthetic mat can be sealed in such a way that the first sealing layer 10 and the non-woven layer 20 as well as the lower second sealing layer 40 and the textile layer 50 protrude laterally beyond the centre filling layer when viewed in the transverse direction and these protruding areas are sewn together in order to also laterally enclose the centre filling layer.

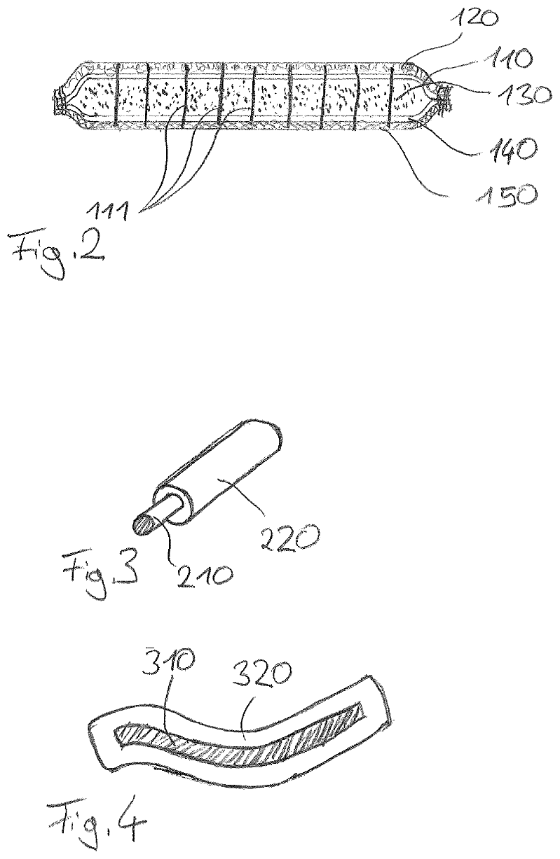

FIG. 2 shows a second embodiment of a geosynthetic mat according to the invention in a cross-sectional longitudinal view. Here too, a centre filler layer 130 is arranged centrally. A first sealing layer 110 and a second sealing layer 140 are arranged above and below, respectively, adjacent to this middle filling layer 130, which are consequently placed directly adjacent to the centre filling layer, in contrast to the first embodiment of FIG. 1. A non-woven layer 120 is then arranged above the first sealing layer 110 as the upper cover layer and a textile layer 150 is arranged below the second sealing layer 140 as the lower cover layer. Again, the individual layers of the geosynthetic mat are fixed and fastened to each other by a needling 111; furthermore, it can be seen that the top cover layer 120, the first sealing layer 110, the second sealing layer 140 and the lower cover layer 150 protrude laterally in the transverse direction and are sewn or needled together along a side edge in order to also laterally seal the middle filling layer 130.

FIG. 3 shows a fibre from which the connecting structure, for example as needling 11, the nonwoven layer 20, 120 or the textile layer 50, 150 can be formed or which can be included in such a layer. The fibre comprises a fibre core strand 210, which consists of a first biodegradable material. A fibre core strand sheath 220 is arranged around the fibre core strand 210 as a cylindrical sheath, which comprises a second biodegradable material. The first biodegradable material has a higher strength and a faster biodegradation rate than the second biodegradable material. If the fibre made up of two layers in this way is subjected to a biodegradation process and at the same time still has to absorb mechanical loads over a limited period of time, this results in a favourable progression of the mechanical load-bearing capacity of this fibre. In this process, the mechanical load-bearing capacity is initially reduced only slightly or not at all, because only the fibre core strand sheathing 220 biodegrades, which makes no significant contribution to the mechanical properties. Only after degradation of the fibre core strand sheath 220 is the fibre core strand 210 also degraded, which then leads to a rapid reduction in the mechanical strength of this fibre.

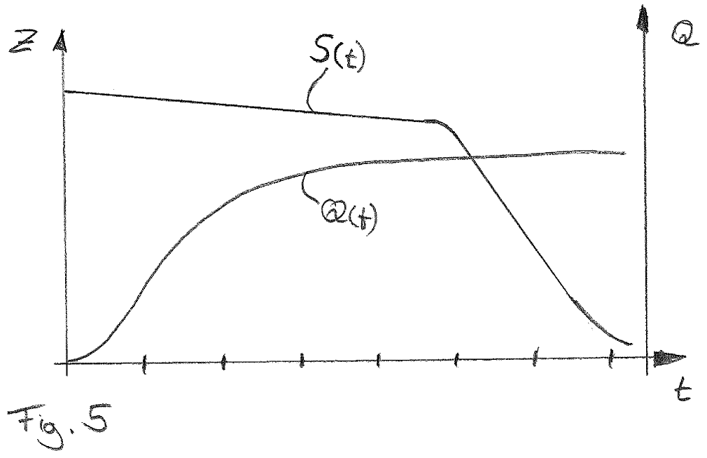

FIG. 4 shows a longitudinally sectioned side view of a short or medium-length fibre according to the invention. This fibre also comprises a fibre core strand 310 which is sheathed by a fibre core strand sheath 320. In terms of their mechanical properties and their biodegradation rate, the fibre core strand and fibre core strand sheathing 310, 320 are designed in a similar way to the previously explained embodiment according to FIG. 3. As can be seen from FIG. 4, the fibre core strand sheathing 320 sheathes the fibre core strand 310 on all sides, i.e., also on the end faces. This is achieved by applying the fibre core strand sheathing 320 only after the fibre core strand 310 has been processed and cut to size, thereby achieving a sheathing on all sides that is favourable for the biological and mechanical degradation behaviour.

FIG. 5 schematically shows the course of the peel strength S(t) of a composite of two needled nonwoven layers, which is composed of fibres according to FIG. 3 or FIG. 4 and consequently comprises or consists of fibres which have a fibre core strand and a fibre core strand sheath. As can be seen from the course of this curve, the curve initially falls only slightly over a first period of time, which consequently corresponds to only a slight reduction in tensile strength. Only at a point in time t, at which the fibre core strand sheathing has largely completely biodegraded, does the peel strength of the composite then fall more steeply, because from this point in time t the fibre core strand biodegrades and the peel strength of the fibre, which is significantly influenced by it, is reduced as a result. In this embodiment example, the overall peel strength of the composite is influenced by the biodegradation of the fibres in the top and bottom cover layers and the connecting structure, i.e., the needling. It should be understood that in other composite systems, isolated degradation behaviour can also significantly or solely influence the decrease in peel strength, for example when a non-biodegradable connecting structure joins two cover layers together, one or both of which are biodegradable, such as can be achieved by stitching. In this case, the peel strength is only influenced by the anchoring strength of the connecting structure in the biodegradable top layer.

FIG. 5 also shows the swelling behaviour of a medium-fill layer in the form of the curve Q(t) as the degree of swelling of the medium-fill layer. As can be seen, after an initial short delay, the centre-fill layer initially increases rapidly in volume, which corresponds to rapid initial swelling, and then changes to a slower increase in volume corresponding to slower swelling, which then asymptotically approaches a final swelling state.

From FIG. 5, it can also be seen that a geosynthetic mat, which would have as its upper and lower cover layer a layer made of fibres which would exhibit the peel strength behaviour according to S(t) and which are also needled with such fibres, would still exhibit a high peel strength during the decisive part of the swelling of the middle filler layer by means of a middle filler layer with a swelling behaviour according to Q(t), would still have a high peel strength during the relevant part of the swelling of the middle filler layer and could therefore counteract the swelling pressure with a sufficiently high counterpressure in order to achieve the desired good homogenisation and removal of the air voids in the middle filler layer as a result of the swelling. The biodegradable fibres of the top and bottom cover layers and the needling are then in the phase of rapid biodegradation and consequently rapid reduction of the peel strength—i.e., a high degree of peel strength reduction—only after the swelling is largely completed and only slight increases in volume and weight of the middle filler layer take place due to residual swelling. At this point, there is no longer any need to apply significant counter-pressure to prevent swelling; instead, the geosynthetic mat benefits from a favourably swollen and sealing middle filler layer.

The calculation of the source-degradation ratio is explained in more detail below using four examples:
(1) The volume of the middle filling layer swelling in the swelling lifting test under a load of 45 Pa after one week of swelling is 40 litres, after three months 50 litres. The volume before swelling began was 20 litres. This results in a doubling of the volume within one week, i.e., a degree of swelling of 2 and a degree of swelling of 2.5 after three months; the peel strength at the beginning of the composting test is 120N/10 cm, this remains virtually unchanged within the first week and the peel strength after three months of composting is 90N/10 cm. This results in a 25% reduction in peel strength after three months, i.e., a residual peel strength of 0.56. This results in a swelling/degradation ratio of 2 after one week and a swelling/degradation ratio of 4.4 after three months.
(2) The volume of the middle filling layer swelling in the swelling lifting test under a load of 45 Pa after one week of swelling is 60 litres, after three months it is 80 litres and then no longer increases significantly. The volume before swelling began was 20 litres. This results in a tripling of the volume within one week, i.e., a degree of swelling 3 and a degree of swelling 4 after three or more months; the peel strength at the beginning of the composting test is 120N/10 cm, this is reduced to 115N/10 cm within the first week, the peel strength after three months of composting is 60N/10 cm and falls to 40N/10 cm by the twelfth month. This results in an approx. 4% reduction to a residual peel strength of 0.96 within the first week, a 50% reduction in peel strength after three months, i.e., a residual peel strength of 0.25 and a residual peel strength of 0.1 after twelve months. This results in a swelling/degradation ratio of 3.1 after one week, which rises to 16 after three months and to 36 after twelve months.
(3) The volume of the middle filling layer swelling in the swelling lifting test under a load of 45 Pa after one week of swelling is 30 litres, after three months 40 litres and after twelve months also 40 litres. The volume before swelling began was 20 litres. This results in a degree of swelling of 1.5 after one week and a degree of swelling of 2 after three and twelve months; the peel strength at the start of the composting test is 120N/10 cm, this remains virtually unchanged within the first week and the peel strength after three months of composting is 90N/10 cm and falls to 60N/10 cm by the twelfth month. This results in a residual peel strength of 0.56 after three months and a residual peel strength of 0.25 after twelve months. This results in a swelling/degradation ratio of 1.5 after one week, which rises to 3.6 after three months and to 8 after twelve months.
(4) The volume of the middle filling layer swelling in the swelling lifting test under a load of 45 Pa after one week of swelling is 40 litres, after three months 60 litres and after twelve months 80 litres. The volume before swelling began was 20 litres. This results in a degree of swelling of 2 after one week and a degree of swelling of 3 after three months and of 4 after twelve months; the peel strength at the beginning of the composting test is 120N/10 cm, this is reduced to 110N/10 cm within the first week, the peel strength after three months of composting is 40N/10 cm and falls to 20N/10 cm by the twelfth month. This results in a residual peel strength of 0.84 after one week, a residual peel strength of 0.11 after three months and a residual peel strength of 0.03 after twelve months. This results in a swelling/degradation ratio of 2.4 after one week, which rises to 27 after three months and 133 after twelve months.

In the present examples, examples 1, 2, and 3 therefore represent geosynthetic mats which have particularly preferred properties according to the invention and achieve good sealing behaviour. The geosynthetic mat according to example 4 exhibits rapid swelling behaviour with respect to rapid biodegradation and the associated loss of peel strength; this geosynthetic mat according to the invention may still achieve good sealing behaviour under a heavy load from an overlying soil layer, but is less suitable if such a weight load is not present to compensate for the rapid biodegradation, because there is then too little counter-swelling pressure to achieve a good seal.

1.-32. (canceled)

33. A geosynthetic mat comprising:
an upper top cover layer;
a lower bottom cover layer;
a middle filler layer arranged between the upper top cover layer and the lower bottom cover layer and consisting of a filler layer material comprising a swellable material, the filler layer material having a swelling behaviour; and
a connecting structure mechanically connecting the upper top and lower bottom cover layers to each other at a plurality of positions through the middle filler layer, the positions of the connection being spaced apart from each other such that the upper top and lower bottom cover layers have a peel strength to each other through the connecting structure;
wherein:
the upper top cover layer and/or the lower bottom comprise a biodegradable material;
the peel strength at a predetermined time after the start of the biodegradation process is characterised by a residual peel strength degree which is formed by the square number of a quotient of a reduced peel strength, which the upper top and lower bottom cover layer and the connecting structure have at the predetermined time, to an initial peel strength, which the upper top and lower bottom cover layer and the connecting structure have before the start of a biodegradation process, wherein the residual peel strength degree is determined:
in a composting test by completely placing the geosynthetic mat in compost and composting in a temperature range above 25° C. and below 65° C. until the predetermined time and measuring the peel strength in a peel test before placing and at the predetermined time after removal from the compost, or
in a marine incubation test, with the following environmental conditions:
temperature 30° C. +/−2° C.; aerobic conditions in seawater with a salt content of 3.5 wt. % +/−1 wt. % and measurement of the peel strength in a peel test before insertion and at the predetermined time after removal from the seawater; and
the swelling behaviour has a degree of swelling lift formed by the quotient of the volume of the filler layer material including the water absorbed therein at the predetermined point in time to an initial volume of the filler layer material before the start of swelling, wherein the degree of swelling lift is determined by completely immersing a layer of filler layer material in a water bath and loading the layer of filler layer material with a pressure of 4.5 N/m², in which a swelling/degradation ratio, which is formed from the degree of swelling divided by the residual peel strength degree, is in a range between 1 and 5 within the first week after the simultaneous start of the swelling process and the biodegradation process and is in a range between 1.5 and 25 from the beginning of the second to the end of the third month after the start of swelling and degradation.

34. The geosynthetic mat according to claim 33, wherein the swelling/degradation ratio from the third month to the end of a twelfth month after the start of the swelling process and the biodegradation process is in a range between 2 and 50.

35. The geosynthetic mat according to claim 33, wherein:
the degree of swelling is greater than 1.25 one week after the start of the swelling process;
the degree of swelling is greater than 1.5 one month after the start of the swelling process;
the residual peel strength degree is less than 0.95 three months after the start of the swelling process; or
the residual peel strength degree is less than 0.75 twelve months after the start of the swelling process.

36. The geosynthetic mat according to claim 33, wherein the connecting structure comprises a needling between the upper top and lower bottom cover layers or is formed by such a needling.

37. The geosynthetic mat according to claim 33, wherein the upper top and/or the lower bottom cover layer or the connecting structure comprises fibres of the biodegradable material or is formed by such biodegradable fibres.

38. The geosynthetic mat according to claim 33, wherein the biodegradable material of the upper top cover layer and the lower bottom cover layer is different from each other; or
the biodegradable material of the upper top cover layer and the lower bottom cover layer is the same.

39. The geosynthetic mat according to claim 38, wherein the biodegradable material of the connecting structure is different from the biodegradable material of the upper top cover layer or the lower bottom cover layer; or
the biodegradable material of the connecting structure is the same as the upper top cover layer or the lower bottom cover layer.

40. The geosynthetic mat according to claim 33, wherein the upper top and/or the lower bottom cover layer comprises a nonwoven layer of the biodegradable material or is formed by such a nonwoven layer.

41. The geosynthetic mat according to claim 33, wherein the upper top and/or the lower bottom cover layer comprises an ordered textile layer, which may include a knitted, woven or crocheted textile layer, of the biodegradable material or is formed by such a textile layer.

42. The geosynthetic mat according to claim 33, wherein the filling layer material comprises a mixture of the swellable material further comprising a bentonite powder, which may include sodium bentonite, and a non-swellable aggregate, which may include an inorganic bulk material comprising sand, glass granulate, chalk or coal granulate, or is formed by such a mixture.

43. The geosynthetic mat according to claim 33, wherein the filler layer comprises a hardening liquid or a liquid leading to hardening, which may include a hard oil or wax or varnish based on linseed oil or tung oil, present on at least a partial area or partial cross-section of the filler layer.

44. The geosynthetic mat according to claim 33, further comprising a upper top barrier layer arranged adjacent to the upper top cover layer and/or a lower bottom barrier layer arranged adjacent to the lower bottom cover layer, wherein each barrier layer is formed by a film made of a biodegradable material, wherein:
the upper top barrier layer is disposed between the upper top cover layer and the middle filler layer;
the lower bottom barrier layer is disposed between the lower bottom cover layer and the middle filler layer,
the upper top cover layer is disposed between the upper top barrier layer and the middle filler layer; or
the bottom top cover layer is disposed between the lower bottom barrier layer and the middle filler layer.

45. The geosynthetic mat according to claim 44, wherein the biodegradable material of the respective barrier layers are either identical or different to the biodegradable material of the upper top or lower bottom cover layer to which the respective barrier layers is adjacent.

46. The geosynthetic mat according to claim 33, wherein the biodegradable material of the upper top cover layer, the lower bottom cover layer, and/or the connecting structure comprises fibres having a fibre core strand of a first biodegradable material and a fibre core strand sheath of a second biodegradable material enveloping the fibre core strand, and wherein the first biodegradable material has a first biodegradation rate that is higher than a second biodegradation rate of the second biodegradable material.

47. The geosynthetic mat according to claim 46, wherein the first biodegradable material comprises a natural fibre which may include coconut fibre, jute fibre, hemp fibre, bamboo fibre or flax fibre, a biodegradable synthetic fibre of PBS, PBAT, PLA or a polymer blend of at least two of these materials, or the biodegradable material comprises a mixture of fibre cores of natural fibres and synthetic fibres, the proportion by weight of the synthetic fibres being greater than 30%.

48. The geosynthetic mat according to claim 46, wherein the second biodegradable material comprises a cellulose-based plastic, a starch blend, lyocell, succinic acid (PBS), a biodegradable polyester which may include polybutyrate adipate terephthalate (PBAT) or polylactic acid (PLA), or a wax.

49. The geosynthetic mat according to claim 33, wherein the middle filling layer has a permeability of between 1×10⁻⁵ and 1×10⁻⁹ m/s.

50. A geosynthetic sheet comprising at least one layer comprising fibres or formed by fibres, wherein the fibres comprise a fibre core strand of a first biodegradable material and a fibre core strand sheath of a second biodegradable material enveloping the fibre core strand, the first biodegradable material having a first biodegradation rate and the second biodegradable material having a second biodegradation rate which is different and higher than the first biodegradation rate of the first biodegradable material.

51. The geosynthetic sheet according to claim 50, wherein the fibres in the layer are configured as:
a disorganised structure, which may include a fleece layer; or
an organised structure, which may include a knitted, woven, or crocheted textile layer.

52. The geosynthetic sheet according to claim 50, wherein the fibres are coated on a circumferential and end faces with the fibre core strand coating and wherein the layer is produced in a process in which a fibre core layer is produced from fibre core strands in a first step and the fibre core strands of the fibre core layer are coated with a coating material in a subsequent second step.

53. The geosynthetic mat according to claim 33, wherein the upper top and/or the lower bottom cover layer comprises a geosynthetic sheet or is formed by such a geosynthetic sheet, the geosynthetic sheet comprising at least one layer comprising fibres or formed by fibres, wherein the fibres comprise a fibre core strand of a first biodegradable material and a fibre core strand sheath of a second biodegradable material enveloping the fibre core strand, the first biodegradable material having a first biodegradation rate and the second biodegradable material having a second biodegradation rate which is different and higher than the first biodegradation rate of the first biodegradable material

54. A method of using a geosynthetic mat according to claim 33 for producing a sealing layer in the ground or at the bottom of a body of water.

55. The method of using a geosynthetic mat according to claim 54, wherein in a first step the geosynthetic mat is rolled out and in a subsequent second step the geosynthetic mat is impregnated with a liquid, which may include an oil, a hard oil, resin, or a varnish.

56. The method of using a geosynthetic mat according to claim 54, wherein in another step the geosynthetic mat is impregnated with a liquid at a first point in time before laying, which causes a partial pre-swelling of the middle filling layer, and is installed in an installation position at a subsequent second point in time at an installation location and swells in the installation position due to the supply of a liquid, which may include a liquid from the surrounding soil.

57. The method of using a geosynthetic mat according to claim 56, wherein in another step the geosynthetic mat is brought into a transportable state after the first point in time, which may include being rolled up and transported to the installation site.

58. The method of using a geosynthetic mat according to claim 54 for producing a sealing layer at the bottom of a body of water, further comprising the step of:
the geosynthetic mat is initially placed on the bottom of a body of water, in that the upper top cover layer of the geosynthetic mat has an open porosity and the outer surface of the upper cover layer has an outwardly facing roughness structure and the geosynthetic mat is laid on the bed of the body of water in such a way that the outer surface of the upper top cover layer faces upwards; and
the middle filling layer has a permeability between 1×10⁻⁵ to 1×10⁻⁹ m/s and particles carried in the water body above the water body become entangled in the roughness structure and migrate through the upper cover layer into the middle filling layer, so that particles carried in the water body are deposited in the middle filling layer and the upper top cover layer forms a sealing layer, which at a second point in time which is after the biodegradation of the upper top cover layer, and creates a supplementary sealing effect within the swollen middle filler layer and an additional sealing layer at the site of the degraded upper top cover layer.

59. The method of using a geosynthetic mat according to claim 58, further comprising the step of laying the geosynthetic mat on the bed of the body of water, wherein the quantity of particles carried in the body of water per volume of water is determined as particle quantity density and the geosynthetic mat is designed in this way, that the swelling-degradation ratio and/or the degree of residual peel strength and/or the thickness of the upper covering layer is designed as a function of this particle quantity density, such that the higher the particle quantity density, the greater the swelling-degradation ratio is designed, the smaller the degree of residual peel strength is designed, and/or the smaller the thickness of the upper covering layer is designed.

60. A method of manufacturing a geosynthetic mat, the method comprising the steps of:
preparing a first geosynthetic layer;
applying a middle filler layer of a filler layer material comprising a swellable material to the first geosynthetic layer, wherein the filler layer material has a swelling behaviour;
laying a second geosynthetic layer on top of the middle filling layer; and
connecting the first and second geosynthetic layers through the middle filling layer by means of a connecting structure, which may include needling;
wherein:
a layer of a first biodegradable material is provided as the first geosynthetic layer and a layer of a second biodegradable material is provided as the second geosynthetic layer;
the upper and lower cover layers have a connection to each other and have a peel strength as a result of the bonding, which connection is characterised at a predetermined time after the start of a biological degradation process by a residual peel strength degree which is formed by the square of a quotient of a reduced peel strength, which the upper and lower cover layers and the connecting structure have at the predetermined time, to an initial peel strength, which the upper and lower cover layers and the connecting structure have before the start of a biological degradation process, which the upper and lower cover layer and the connecting structure have before the start of a biodegradation process, wherein the residual peel strength degree is determined in a composting test by completely placing the geosynthetic mat in compost and composting in a temperature range which is above 25° C. and below 65° C. up to the predetermined time and measuring the peel strength in a peel test before placing and at the predetermined time after removal from the compost;
the swelling behaviour is characterised by a degree of swelling lift, which is formed by the quotient of the volume of the filler layer material including the water absorbed therein at the predetermined point in time to an initial volume of the filler layer material before the start of swelling, wherein the degree of swelling lift is determined by completely immersing a filler layer material layer in a water bath and loading the filler layer material layer with a pressure of 4.5 N/m²; and
a swelling/degradation ratio, which is formed from the degree of swelling divided by the residual peel strength degree, is in a range between 1 and 5 within the first week after the simultaneous start of the swelling process and the biodegradation process and is in a range between 1.5 and 25 within each predetermined point in time from the beginning of the second to the end of the third month after the start of swelling and degradation.

61. The method according to claim 60, wherein:
a layer of a first biodegradable material is provided as a first geosynthetic layer and a layer of a second biodegradable material is applied as a second geosynthetic layer; and
the first and/or the second biodegradable material is in fibre form, which may include fibres which have a fibre core strand of a first fibre biodegradable material and a fibre core strand sheath of a second fibre biodegradable material, the first fibre biodegradable material having a first biodegradation rate which is higher than a second biodegradation rate of the second fibre biodegradable material.

62. The method according to claim 61, wherein the first and/or second cover layer is produced from the fibre core strands in a first step and in a subsequent second step the fibre core strands in the first and/or second cover layer are sheathed with the fibre core strand sheathing.

63. The method according to claim 61, wherein the upper and/or the lower top layer, the middle filling layer or the entire geosynthetic mat are impregnated with a liquid, which may include a water-repellent liquid such as a hard oil or a varnish based thereon.

64. The method according to claim 61, wherein a non-swellable aggregate, which may include sand, is additionally applied when the middle filling layer is applied.
